(19) United States
(12) Patent Application Publication
(10) Pub. No.: US 2024/0302608 A1
(43) Pub. Date: Sep. 12, 2024

(54) CONTROLLED ATTENUATION OF A REFLECTION FROM A COATED SURFACE

(71) Applicant: Samtec, Inc., New Albany, IN (US)

(72) Inventors: Stephen M. GIRLANDO, New Albany, IN (US); Christopher A. BANDFIELD, New Albany, IN (US); John L. NIGHTINGALE, New Albany, IN (US)

(21) Appl. No.: 18/283,555

(22) PCT Filed: Apr. 5, 2022
(86) PCT No.: PCT/US2022/023477

§ 371 Date: Sep. 22, 2023

Related U.S. Application Data
(60) Provisional application No. 63/171,937, filed on Apr. 7, 2021.

(51) Int. Cl. G02B 6/42

(52) U.S. Cl. CPC G02B 6/4214

(57) ABSTRACT

An optical block includes a first surface that receives light entering the optical block, a second surface through which the light exits the optical block, and a reflector that reflects light from the first surface towards the second surface. The reflector includes a reflective surface formed by a coating which is textured to attenuate the light transmitted through the optical block. The reflective surface is encapsulated so that its reflective properties are not affected by liquids or contaminants on an outer surface of the coating.

### CROSS REFERENCE TO RELATED APPLICATIONS

This application claims the benefit of U.S. Patent Application No. 63/171,937 filed on Apr. 7, 2021. The entire contents of this application are hereby incorporated by reference.

### BACKGROUND OF THE INVENTION

### 1. Field of the Invention

The present invention relates to an optical block with a coated reflective surface that has been modified to attenuate reflection from the coated reflective surface.

### 2. Description of Related Art

Good modulation characteristics of high-transfer-rate data include having high and uniform contrast between the “on” (digital 1) and “off” (digital 0) states. To provide good modulation characteristics, a laser is typically operated in an optical communication system that generates the high-transfer-rate data at a current well above the laser threshold current, which can generate an excessively large amount of light transmitted through an optical fiber. The laser is typically incorporated into an optical engine located in an optical transceiver or optical transmitter that is part of the optical communication system. Optical transceivers, transmitters, and receivers in the optical communication system are typically connected to each other through optical fibers. High optical power levels in an optical fiber can cause detector saturation in a receiver and/or induce signal distortion through optical nonlinearities. Thus, the amount of light is preferably attenuated before it enters the optical fiber.

To attenuate the light before entering an optical fiber, it is known to use an optical attenuator in the optical path of the light. The optical path can include an optical block, and it is known to use an optical block made from different materials with different attenuation characteristics, for example, 1 dB, 2 dB, etc. It is also known to use an in-line optical attenuator. For example, a thin-film on a glass substrate or a bulk absorptive attenuator can be used in the optical path. It is also known to defocus the light before it enters the optical fiber. The techniques described above have the disadvantage that all channels must have the same attenuation and cannot adapt to part-to-part variations. In addition, for bidirectional transceivers that include both transmit and receive channels in the same optical block, it can sometimes be difficult with the above techniques to only attenuate the transmit channels, which is desired to not reduce the sensitivity of the receive channels. Adding an attenuator increases the part count and adds cost and complexity. Multi-channel devices can require multiple attenuation blocks with different attenuation levels.

Another method to attenuate light coupled into an optical fiber is defocusing the light to decrease the coupling into the optical fiber. This method can result in the excitation of undesirable cladding modes. Defocusing the light can increase the mechanical adjustment range that is able to provide a predetermined degree of attenuation. If the optical fibers are arranged in an optical fiber ribbon, then the attenuation of each optical fiber cannot be individually adjusted because all the optical fibers are mechanically linked.

Another known method of reducing the amount of light coupled into a fiber, disclosed in U.S. Pat. No. 10,884,198 ('198 patent) is to deliberately spoil the reflectivity of a total internal reflection (TIR) surface by texturing the surface. The '198 patent is entitled Optical Block with Textured Surface, was filed 23 Mar. 2016, is owned by the applicant, and is hereby incorporated by reference in its entirety. The system and method described in the '198 patent work well in many situations, but it requires the TIR surface to remain free of contaminants from the surrounding environment, so as not to alter its reflective properties.

One known solution to this problem is to seal the TIR surface to isolate the TIR surface from possible contaminants. The attenuation method and system described in the '198 patent has been incorporated into a sealed optical transceiver or transmitter as described in PCT patent application No. PCT/US2020/013994 ('994 patent application). The '994 patent application is entitled Sealed Optical Transciever, was filed 17 Jan. 2020, is owned by the applicant, and is hereby incorporated by reference in its entirety.

Sealing the transceiver or transmitter, as described in the '994 patent application, allows the transceiver or transmitter to operate in harsh environments, such as salt spray and fog. The sealing also enables the transceiver or transmitter to be cooled by immersion cooling in a liquid, which can enable higher density interconnection systems.

While the system and method disclosed in the '994 patent application works well in some applications, this system and method add the complexity and the cost of sealing the reflective TIR surface from possible contaminants that may be present in the surrounding environment without altering its reflective properties. Accordingly, the system and method disclosed in the '994 patent application typically require at least one additional part and may increase the size of the transceiver or transmitter.

Thus, there is a need for a method and apparatus that can reduce the transmitted light to an appropriate level without adding additional components and mechanical complexity and that does not require the reflective surface to be isolated from the surrounding environment.

### SUMMARY OF THE INVENTION

An embodiment of the present invention includes an optical block that provides attenuation on a textured coated reflective surface. An optical block includes a first surface arranged to receive a light beam having an input optical power, a second surface arranged to output the light beam from the optical block, a reflective surface arranged to receive the light beam from the first surface and redirect the light beam to the second surface. The reflective surface includes a coating, and the coating is textured to deliberately spoil the reflective surface causing the input optical power to be attenuated so that the output optical power has a predetermined output optical power. The reflective surface is encapsulated so that its reflective properties are not affected by liquids or contaminants on an outer surface of the coating.

The optical block can further include a plurality of data transmission channels. An attenuation level of at least two of the plurality of data transmission channels can be different or can be the same attenuation level.

The coating can include a reflective layer that is covered by an encapsulant layer. The coating can include an adhesion layer provided between the optical block and the reflective layer.

The texture can be uniform or substantially uniform over an intersection region where an optical path of the light beam intersects with the reflective surface. The texture can be defined by a plurality of locally modified regions. The texture can be defined by defects in the coating. The defects can include laser markings. The defects can be arranged in a regular array or can be random.

The first surface, the reflective surface, and the second surface can be provided in a first reflector, and the optical block can further include a second reflector with a second reflective surface. The second reflective surface does not have to include a textured coating.

An embodiment of the present invention includes a sealed optical engine including the optical block according to one of the various other embodiments of the present invention, and a sealed component chamber.

The sealed optical engine can further include a photodetector adjacent to the coating that captures a portion of the light beam that leaks through the reflective surface. The photodetector can monitor the input optical power.

In another embodiment of the present invention, a method of forming a textured coating is provided. The method of attenuates an output optical power of a light beam reflected from a reflective surface to a predetermined output power level. The reflective surface is deliberately damaged to attenuate the output optical power of the light beam to a predetermined intermediate output power level. An encapsulant is then applied to change the output power level to the predetermined output power level, the predetermined output power level being different than a target intermediate power level. In some embodiments, there may be a plurality of light beams and the attenuation level of each light beam can be individually adjusted so that each light beam has a predetermined output power level.

Deliberately spoiling the reflective surface can include raster scanning a pulsed laser over a coating of the reflective surface. The attenuated light beam can be coupled into an optical fiber. The method can further include a plurality of light beams reflected from the reflective surface to a predetermined output power level. An attenuation level of each of the plurality of light beams can be individually adjusted. The predetermined output power level of each of the plurality of light beams can be the same power level.

The reflective surface can include a reflective layer that is spoiled to attenuate the light beam. The reflective layer can ablated by a pulsed laser.

In other embodiments of the present invention, an optical data transmission system including a coated textured reflective surface is arranged to attenuate an optical beam. The reflective surface is encapsulated so that its reflective properties are not affected by liquids or contaminants on an outer surface of the coating.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 is an exploded view of a prior art optical engine.

FIG. 2 is a cross-sectional view that shows an optical path of the prior art optical engine shown in FIG. 1.

FIG. 3 is a cross-sectional view of a portion of the prior art optical engine that can be modified to use embodiments of the present invention.

FIG. 4 is cross-sectional view of an optical block according to an embodiment of the present invention.

FIG. 5 shows a cross-sectional view of a portion of a reflector prior to texturing according to an embodiment of the present invention.

FIG. 6 shows top view of an optical block according to an embodiment of the present invention.

FIG. 7 shows a portion of an optical bock with a textured area on a reflector according to an embodiment of the present invention.

FIG. 8 is a flowchart diagram showing a process of adjusting an attenuation level in all channels of an optical engine according to an embodiment of the present invention.

FIG. 9 shows a cross-sectional view of a portion of the reflector with a power monitor according to an embodiment of the present invention.

FIG. 10 shows a textured reflector according to an embodiment of the present invention.

FIG. 11 is a cross-sectional view that shows an optical path of an optical engine according to an embodiment of the present invention.

### DETAILED DESCRIPTION

The embodiments of the present invention can be used in any application in which a beam of light is attenuated. A particular application of the embodiments of the present invention is to attenuate optical power coupled into an optical fiber by an adjustable amount in an optical engine that is included in of an optical transceiver or optical transmitter. The optical transceiver or optical transmitter may be located at an end of an active optical cable.

The optical engine typically includes electro-optical (EO) components connected to a substrate. The optical engine can also include a molded optical structure (MOS) or an optical block that connects to the substrate to optical fibers of an optical cable. Instead of optical fibers, any suitable optical waveguide or optical interconnect can be used. The optical block provides an interface with the substrate at a position adjacent to the EO components. In some embodiments, optical paths through the optical block between the EO components and the optical fibers can include a lens system and a reflecting surface. The reflecting surface redirects a light path, which can facilitate aligning and mounting the optical fibers. The lens system controls the beam sizes, which can provide good coupling efficiency between the various elements in the optical path. The optical engine can include a plurality of data transmission channels, each channel including an associated optical path. The optical engine can include a receive side and a transmit side, and each side can include a plurality of channels.

The optical engine can be used in numerous computer connector systems including, for example: QSFP(+), CX4, CX12, SFP(+), XFP, CXP active optical cables; USB, CIO active optical cables; MDI, DVI, HDMI, Display Port, UDI active optical cables; PCIe x1, x4, x8, x16 active optical cables; SAS, SATA, MiniSATA, QSFP-DD, OSFP active optical cables.

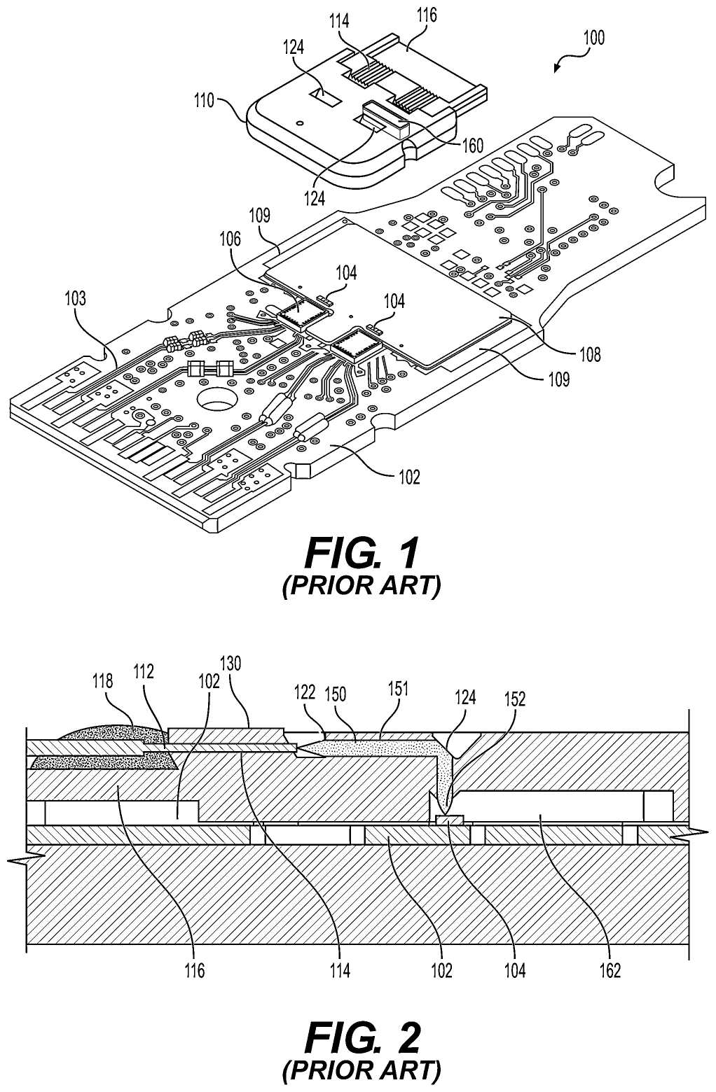

FIG. 1 is an exploded view of a portion of a prior art optical engine 100, and FIG. 2 shows an optical path 150 through the optical engine 100. FIGS. 1 and 2 in this application are similar to FIGS. 1 and 2 in the '198 patent. The optical engine 100 includes a substrate 102, EO components 104 connected to the substrate 102, optical block 110 connected to the substrate 102, and optical fibers 112 connected to the optical block 110. The optical engine 100 can be implemented with either single mode optical fibers or multi-mode optical fibers.

A data transmission channel, or simply channel, is defined by a single path along which signals are transported, that is, transmitted and/or received. FIGS. 1 and 2 show a channel that includes an optical fiber 112, an optical path 150, an EO component 104, and an electrical trace 103. A transmitting channel includes electrical signals that are inputted to the optical engine 100 at the edge of substrate 102, that propagate along the trace 103, that are converted to optical signals in the EO component 104, and that continue to the optical fiber 112. A receiving channel includes optical signals that are inputted to the optical engine 100 at the optical fibers 112, that are converted to electrical signals in the EO component 104, and that propagate along the trace 103 to the edge of the substrate 102.

The EO components 104 include, but are not limited to, laser diodes or laser diode arrays for transmitting channels and photodetectors or photodetector arrays for receiving channels. The laser diode can produce either a single-transverse-mode output beam or a multi-transverse-mode output beam. The laser diode converts an electrical current into light. A laser diode can be, for example, a vertical-cavity surface-emitting laser (VCSEL), but other electrical-to-optical converters could also be used. The photodetector converts received light into a current. Any suitable photodetector can be used. The EO components can be electrically connected to traces 103 on the substrate 102 using either wire bonds or flip-chip techniques.

The optical block 110 can be connected to the substrate 102 at a position adjacent the EO components 104, for example. The optical block 110 includes a lens system that focuses and directs light from the optical fibers 112 onto the EO components 104 and/or focuses and directs light from the EO components 104 into the optical fibers 112. The optical block 110 can be made of a single injection-molded optical component or any other suitable device.

The optical block 110 may include grooves 114 that align and help secure the optical fibers 112 in the optical block 110. However, structures other than the grooves 114 may be provided to align the optical fibers 112. The grooves 114 can be V-shaped grooves or any other suitably shaped grooves. Each of the grooves 114 receives and aligns a corresponding optical fiber 112 in the optical block 110. A pressure plate 130 secures the optical fibers 112 in the grooves 114. The optical block 110 can include a strain-relief section 116 that extends beyond the grooves 114. Epoxy 118 can be used to secure the optical fibers 112 to the strain relief section 116. By including the grooves 114, assembly techniques can be applied in which the optical fibers 112 are held in a clamp and stripped, cleaved, passively aligned, and permanently attached to the optical block 110 in a single operation.

The optical block 110 can include one or more optical paths 150 through the optical block 100. Each optical path 150 can include a first lens 126 positioned at a first end of the optical path 150 and a second lens 122 positioned at a second end of the optical path 150. The first and second lenses 122, 126 can collimate the light, for example. The second lens 122 is adjacent to the optical fibers 112 and the first lens 126 is adjacent to the EO components 104, but other structures and arrangements can be implemented. One or both of the first lens 126 or the second lens 122 can have no optical power, that is, one or both of the first lens 126 or the second lens 122 can have a flat surface. Each optical path 150 further includes a reflector 124 positioned between the first lens 126 and the second lens 122. The reflector 124 redirects light so the optical path is bent or redirected. The bend in the optical path can be approximately 90 degrees, but the bend in the optical path can be implemented with other angles.

Each optical path 150 includes a second section 151 and a first section 152. The second section 151 includes a second lens 122 at a second end of the second section 151 and a reflector 124 at a first end of the second section 151. The second lens 122 can be adjacent to the optical fibers 112, but other structures and arrangements can be implemented. The first section 152 includes the reflector 124 at a second end of the first section 152 and a first lens 126 at a first end of the first section 152.

The optical block 110 can include a component cavity 162 that creates an enclosed space between the planar surface of the substrate 102 and the optical block 110 for the EO components 104 mounted on substrate 102. This component cavity 162 may be sealed to isolate it from the surrounding environment.

The substrate 102 can be any suitable substrate, including, for example, an organic substrate (for example, FR4) or a ceramic substrate (for example, alumina). The substrate 102 can include electrical traces 103 that are used to route electrical data signals. The EO components 104 can include EO converters. Semiconductor chips 106 can be provided on the substrate 102, and the semiconductor chips 106 can drive the EO converters. The semiconductor chips 106 can include, for example, analog chips that drive the EO converters. The semiconductor chips 106 that electrically drive the EO converters can include, for example, a laser diode driver for the laser, and a trans-impedance amplifier (TIA) for the photodetector. The components of the optical engine 100 can be surface mounted to one side of the substrate 102 using standard semiconductor assembly processes.

A riser 108 can be connected to the substrate 102. The riser 108, which can be formed from metallic or ceramic compositions, for example, defines and functions as a planar mechanical reference that receives and aligns the EO components 104 and the optical block 110. The riser 108 is also used to conduct heat generated by the EO components 104 and/or the semiconductor chips 106 to one or more side or edge regions 109 of the optical engine 100.

The optical engine 100 can be manufactured using single-sided, surface-mount component assembly along with a two-step alignment process. The EO components can be bonded on the substrate 102 relative to fiducial marks by a precision die bonder. The EO components 104 for receiving channels and transmitting channels can be aligned and bonded precisely relative to each other. The optical block 110 can be aligned and bonded precisely relative to the EO components 104. The optical block 110 includes the grooves 114 to provide precise alignment of the optical fibers 112, and the optical fibers 112 can be passively placed in the grooves 114 and attached to the optical block 110. Accordingly, the optical fibers 112 can be directly attached and aligned to the optical block 110.

For transmitting channels, the electrical signal coming from the electrical interface can be routed and wirebonded from the substrate 102 to a laser diode driver, for example. The laser diode driver can be wirebonded to the laser diodes. For receiving channels, the electrical signal coming from the photodetector can be wirebonded to the TIA. The TIA can be wirebonded to the substrate 102 that route the electrical signals to the electrical interface. These components can be mounted using any suitable technique, including being flip-chip mounted.

Instead of, or in addition to, using an open cavity 160 or partially transmitting optical block 110 to attenuate light entering the optical fiber 112, the reflector 124 can be modified to attenuate the amount of light that enters the optical fiber 112. For example, the reflectivity of the reflector 124 can be reduced by defeating, spoiling, or degrading the surface of the reflector 124. Reduction of the surface reflectivity can be provided by roughening, scratching, dimpling, or otherwise providing a fine pitched mechanical texture to the surface of the reflector 124. The textured surface on the reflector 124 is generally formed only on transmitting channels where attenuation of the optical power in the optical fiber is to be provided. The reflector 124 on receiving channels can remain untextured.

FIG. 3 shows a cross-section of a portion of the prior art optical engine 100. A laser 105 can be mounted on substrate 102. The laser 105 can be any suitable laser including a VCSEL. The laser 105 can include one or more individual laser emitters. The laser 105 can provide a modulated optical signal suitable for very high bandwidth signal transfer in an optical channel, for example, in a range of about 1 Gbps to about 28 Gbps or higher. The laser 105 generates a light beam that follows the optical path 150. A first lens 126 can be provided on a surface of the optical block 110. The first lens 126 can collimate or focus the light emitted by the laser 105. The reflector 124 can include a coated surface that specularly reflects some light (reflected light follows the optical path 150) towards the optical fiber 112 (not shown in FIG. 3). The reflector 124 has been textured so that the reflected optical power is attenuated by some combination of transmission through the reflective surface, scattering off the reflective surface, or absorption in the reflective surface. A textured surface is defined as a surface with deliberately formed defects that degrade the optical quality of the surface. A process of texturing the reflector 124 can be, for example, to selectively remove or modify many small areas of the coating so that its reflective properties are altered. These small, effected areas may be arranged in a uniform or substantially uniform pattern, within manufacturing tolerances, across the reflector 124.

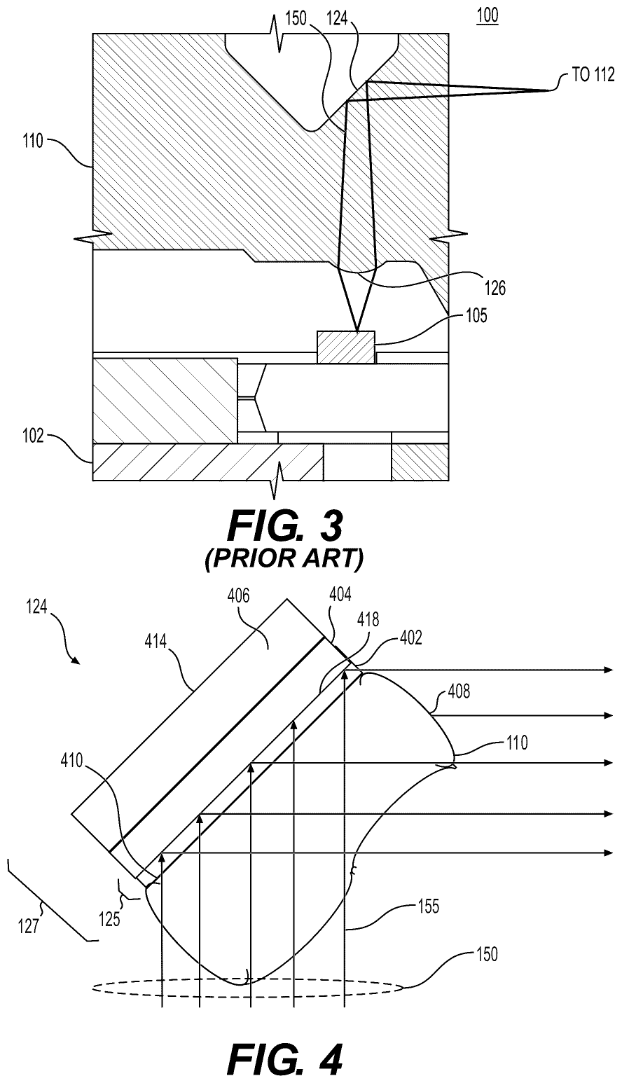

The reflector 124 can be coated such as with a metal or dielectric coating as shown in FIG. 4, which is a cross-sectional view of a portion of the reflector 124. The coating may include multiple layers, shown as a first layer 402, a second layer 404, and a third layer 406 in FIG. 4. The first layer 402 is provided on a surface 410 of a bulk material 408 that defines the optical block 110. The second layer 404 is provided on the first layer 402 on the side opposite the bulk material 408. The third layer 406 is provided on the second layer 404 on the side opposite the first layer 402. The first layer 402 may be an adhesion layer including materials that are selected according to their adhesion properties with respect to the surface 410. The first layer 402 may be applied to the bulk material 408, or the first layer 402 may be a treatment of the surface 410 that prepares the surface 410 for application of the second layer 404. The first layer 402 has low absorption at the laser operating wavelength, so that light striking the first layer 402 can pass through to the second laser 404. The second layer 404 may be a reflective layer. The second layer 404 can have a high reflectivity at an operating wavelength of the laser 105, for example, a reflectivity of about 90% or higher. As a more specific example, the second layer 404 can have a reflectivity of about 95% or higher at an operating wavelength of about 850 nm. The second layer 404, when applied, may be optically thick, meaning that no light or substantially no light penetrates the reflective layer 404 prior to texturing. Some or all the specular reflection occurs at the interface between the first layer 402 and the second layer 404. The third layer 406 may be an encapsulating layer. The encapsulating layer isolates all other layers and the surface 410 from the surrounding environment. The third layer 406 may be transparent, translucent, or opaque at the operating wavelength of the laser 105.

The first layer 402, the second layer 404, and the third layer 406 may be applied by any known process, for example, vapor deposition, plating, liquid dispensing, as a free-standing film, or the like. The first layer 402, the second layer 404, and the third layer 406 may be applied by the same or different processes. In an embodiment, the first layer 402 may be an adhesion layer, the second layer 404 may be a metal layer (for example, gold, copper, or silver), and the third layer 406 may be a polymer layer. Collectively, the first layer 402, the second layer 404, and the third layer 406 may be referred to as a coating 127. The surface 410 and an interface 418 between first layer 402 and the second layer 404 collectively define a reflective surface 125 formed by the coating 127. Specular reflection can occur at both the surface 410 and the interface 418 between the first layer 402 and second layer 404. While the coating 127 defining the reflective surface 125 shown in FIG. 4 has three layers, in other embodiments more layers or fewer layers may be included.

In practice, the layers shown in FIG. 4 may have very different thickness and the relative thickness shown in FIG. 4 may not be representative of the actual thickness differences. The thickness of the first layer 402 may be selected based on its adhesion properties and thus may be very thin, for example, less than about 1 micron or less than about 100 nm. The thickness of the second layer 404 may be sufficiently thick so that the layer 404 is optically opaque prior to texturing. For a metal of the second layer 404 (for example, gold) only a thin layer can be provided, for example, a layer having a thickness of about 2000 Å to about one micron. However, the thickness of the metal of the second layer 404 can be adjusted according to the specific metal included and according to the operating wavelength of the laser 105. The thickness of the third layer 406 is not critical, and it may be relatively thick, since an outer surface 414 of the third layer 406 is not a portion of the reflective surface 125. The thickness of the third layer 406 may be, for example, greater than about 10 microns. The above dimensions are provided as examples, and other thickness may be provided.

FIG. 4 also shows the optical path 150 shown as a series of rays 155. FIG. 4 shows all the rays being reflected off the interface 418 between the first layer 402 and the second layer 404. In practice, some reflection may also occur at the surface 410. As shown in FIG. 4, all rays 155 are specularly reflected by the reflective surface 125. In practice, there will be some absorption and scattering that is inherent in any material or interface, but these losses are generally negligible and can be as small as losses that occur in known reflectors. These intrinsic losses are distinct from losses that are deliberately introduced into the coating 127 by introducing a plurality of defects into the coating 127.

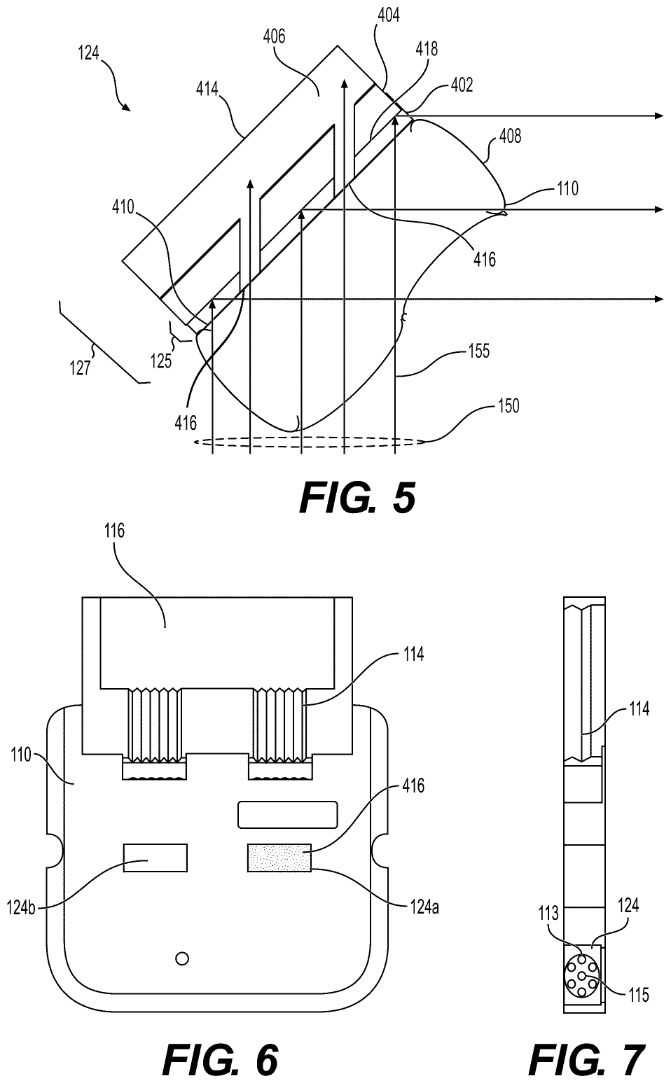

The third layer 406 may be deposited on the first layer 402 and the second layer 404 after texturing the first layer 402 and the second layer 404. The resulting coating 127 is shown in FIG. 5. In FIG. 5, the first layer 402 and the second layer 404 have been removed over a portion of the surface 410 and the third layer 406 has filled the void created by the removal of the first layer 402 and the second layer 404. In locally modified regions 416, the reflective properties of the coating 127 been locally modified so that specular reflection off the coating 127 is reduced. This reduction in specular reflection is shown in FIG. 5 by some rays 155 being specularly reflected off the reflective surface 125 and some rays 155 passing through the reflective surface 125. While FIG. 5 shows the surface 410 being unaffected by the texturing and the rays 155 passing straight through the surface 410, this is not necessarily the case. The surface 410 may be deformed to be not planar. The refractive index of the third layer 406 may be different from the refractive index of the bulk material 408 of the optical block 110, and rays 155 passing through surface 410 may be bent by refraction. Additionally, residue amounts of the first layer 402 and/or the second layer 404 may remain in the locally modified regions 416, and these residue amounts of the first layer 402 and/or the second layer 404 can scatter or absorb the rays 155. The locally modified regions 416 may not extend all the way to the surface 410 and may only modify the interface 418 between first layer 402 and second layer 404 where all or most of the specular reflection occurs.

Including the third layer 406 to encapsulate the reflective surface 125 isolates the reflective surface 125 from its surroundings. Thus, the reflective properties of the reflective surface 125 are unaffected by possible liquids, contaminants, or solid particles that may contact the outer layer 414 of the reflector 124.

FIG. 6 shows a top view of the optical block 110. The optical block 110 includes two reflectors 124a and 124b that direct light between an array of optical fibers 112 and EO components (not shown in FIG. 6). The optical block 110 shown in FIG. 6 can include twelve grooves 114 that can receive twelve optical fibers 112 (not shown in FIG. 6), and thus potentially twelve high-speed optical channels. Reflector 124a has been textured with a plurality of the locally modified regions 416. Reflector 124b has been left untextured. Reflector 124a may be included on the transmit channels, where attenuation of light entering the fibers 112 is to be provided, and reflector 124b may be included on the receive channels, where attenuation of light entering the EO component (for example, a photodetector) is not required.

FIG. 7 shows an example of a textured pattern on the surface of the reflector 124. The textured pattern can be uniform or substantially uniform, within manufacturing tolerances, over the intersection region 113 where the optical path 150 intersects with the surface of the reflector 124. The textured pattern can be an array of defects 115 in the coating as shown in FIG. 7. The defects 115 correspond to the locally modified regions 416 shown in FIG. 5 where the first layer 402 and the second layer 404 have been removed and the resultant void subsequently filled by the third layer 406. The defects can be formed by laser marking or another suitable process. The size of the defects 115 in FIG. 7 has been exaggerated for clarity. Any number of defects 115 can be provided. For example, tens, hundreds, or thousands of defects 115 can be provided in the reflector 124. The size and/or the number of defects 115 can be adjusted to control the level of attenuation. Increasing the number of defects 115 and making the defects 115 larger tends to increase the amount of attenuation. The defects 115 can be formed in a regular array, or the defects 115 can be formed randomly to reduce possible patterns that may introduce undesired interference artifacts in the reflective properties of reflector 124.

The textured surface of the reflector 124 can be made by a laser machining process, although other processes can be applied. In the laser machining process, a laser is directed and optionally focused on the surface of the reflector 124 after application of the first layer 402 and the second layer 404. Application of the laser to the surface of the reflector 124 provides a spatially localized, mechanical, physical, or chemical alteration of at least the second layer 404. Although FIG. 5 shows that the first layer 402 and the second layer 404 are removed, the first layer 402 and the second layer 404 are not required to be removed. The one or more layers of the coating 127 can be altered so that at least the reflective properties of the reflective surface 125 are changed. This alteration in the reflective surface 125 degrades the specular reflectivity resulting in attenuation of the specularly reflected beam. For example, the textured surface can cover or can substantially cover, within manufacturing tolerances, the intersection region 113. Covering the entire intersection region 113 provides a uniform or substantially uniform reduction in the specularly reflected light, without impacting the spatial distribution of the light. The coupling tolerances to the optical fiber 112 are thus not impacted by the texturing, and only the magnitude of the specularly reflected light is impacted. However, a predetermined level of attenuation is also able to be provided by selectivity degrading the reflector 124 over only a portion of the intersection region 113.

The coating 127 can be modified by any number of processes. For example, a pulsed laser can be used to locally ablate one or more of the first layer 402, the second layer 404, and the third layer 406. In particular, lasers operating at ultraviolet wavelengths can be used. Pulsed lasers based on Q-switching or fiber amplifiers converted to UV wavelengths in a vicinity of about 355 nm using nonlinear optical processes are examples of classes of lasers that can be used to modify the coating 127. Other wavelengths in the infrared or visible wavelengths may also be used. The pulse length of the laser can be in the femtosecond, picosecond, nanosecond, or microsecond range.

Mechanical scribing or scratching of the layers can also be implemented. For example, an array of sharpened pins can be pressed or dragged across the first layer 402 and the second layer 404. The array of sharpened pins can be made using MEMS (Micro-Electronic Mechanical Systems) processing techniques, for example. However, other processes can be implemented to provide the array of sharpened pins.

The locally modified regions 416, shown in FIG. 5, can be referred to as defects or spots, independent of how the spots or defects are formed. Spot sizes can be a small percentage of the overall beam size. For example, if the optical path 150 provides a beam size of about 200 microns on the surface of the reflector 124, then spot sizes can be less than about 25 microns. However, the spot size can be on the order of about 1 micron in some applications. A smaller spot size generally provides a more uniform attenuation of the light intensity. Accordingly, the fraction of emitted light coupled into the optical fiber 112 can be independent of the spatial distribution of the emitted light. A further advantage of small spot sizes is that small spot sizes provide better resolution to control the amount of light coupled into the optical fiber 112. Furthermore, many spots can be made in a millisecond, and an array of spots can be made in less than one second.

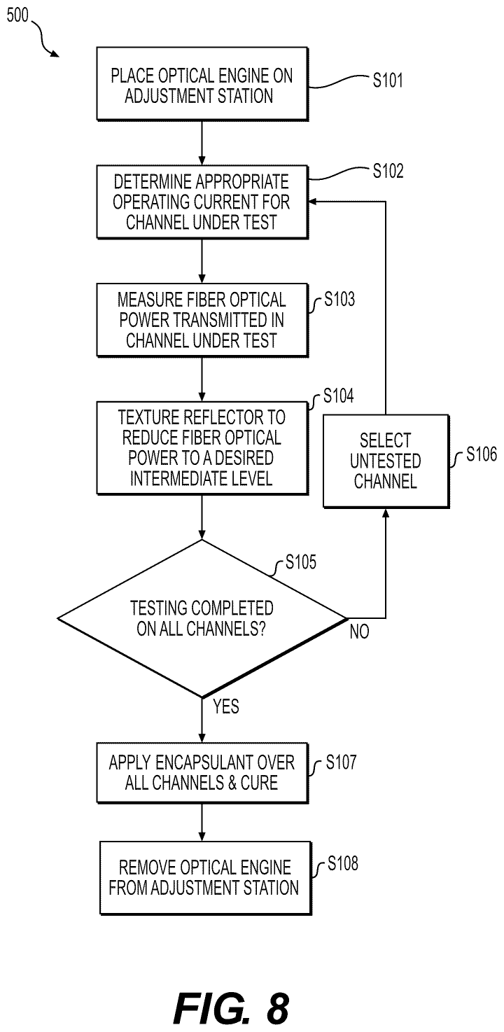

The degree of optical attenuation in an optical engine can be adjusted according to the process 500 shown in FIG. 8. In step S101, the optical engine can be mounted on an adjustment station. The adjustment station is able to both drive a laser under test and measure the light transmitted from the optical fiber associated with the laser under test. In step S102, a laser operating point can then be determined according to a drive current that yields predetermined modulation characteristics. As described above, this drive current can produce an excessively large optical signal level in the optical fiber. In step S103, the light in the optical fiber is measured. In step S104, the signal level in the optical fiber can be decreased by texturing the surface of the reflector. For example, the size and extent of alteration of the spots can be increased by striking a spot with multiple laser pulses to reduce the amount of light coupled into the optical fiber. For example, a focused laser spot can be raster scanned over the reflective surface 124, and the optical power level in the optical fibers 112 can be measured. To provide further attenuation, then the laser spot can be raster scanned over the same pattern, increasing the degree of texturing of the reflective surface 124 and thereby increasing the attenuation level. The texturing can proceed until a predetermined intermediate fiber optical power level is provided. In step S105, a determination is made as to if all of the channels have been tested and had their respective optical power levels in the optical fibers 112 adjusted. If all the channels have not been tested (the “No” decision in step S105), then in step S106 an untested channel is selected. If all the channels have been tested (the “Yes” decision in step S105) the process proceeds to step S107 in which an encapsulant is applied over all channels. The encapsulant may be the third layer 406 shown in FIG. 5. The encapsulant is then cured. Applying the encapsulant can alter the reflective properties of the reflective surface 125 and thus the intermediate power level may be different than a predetermined final output power level. The change in power level introduced by the encapsulant may be determined by prior testing on similar parts and thus a target intermediate power level can be determined. In step S108, the optical engine is removed from the adjustment station.

The process 500 shown in FIG. 8 may be described as a process of attenuating an output optical power of a light beam reflected from a reflective surface to a predetermined output power level. The reflective surface is deliberately spoiled or damaged to attenuate the output optical power of the light beam to a predetermined intermediate output power level. An encapsulant in then applied to change the output power level to the predetermined output power level, the predetermined output power level being different than the target intermediate power level. In some embodiments, there may be a plurality of light beams and the attenuation level of each light beam can be individually adjusted so that each light beam has a predetermined output power level. The predetermined output power level of each of the plurality of light beams may be the same within manufacturing tolerances. In some cases, this results in an attenuation level on all of the multiple data transmission channels being the same within manufacturing tolerances.

Predetermined attenuation levels for optical channels can differ between the optical channels. In the embodiments of the present invention, the attenuation level can be readily adjusted by changing the degree of texturing for each channel, in contrast to prior art techniques that include a bulk attenuator having a substantially uniform attenuation for all channels. In the embodiments of the present invention, the predetermined attenuation level in each channel can be provided without adding an extra component, for example, an attenuator, to the optical engine 100. The embodiments of the present invention also can significantly reduce or eliminate the need to stock a wide variety of attenuators having different attenuation levels. Embodiments of the present invention can also adjust the attenuation level to more than about 10 dB of the incident light. While any predetermined level of attenuation can be provided, attenuation levels are typically between about 2 dB and about 5 dB. In addition, small spots can be included to provide an attenuation resolution of about 0.01 dB in each channel, although some applications may not require such a fine attenuation resolution.

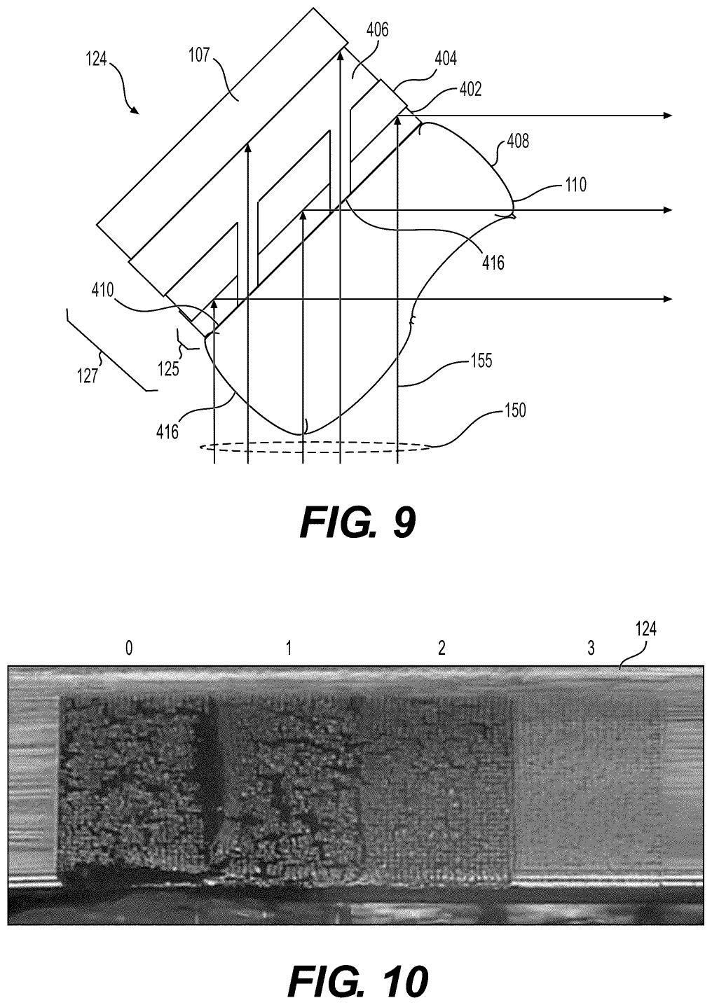

Optionally, a photodetector 107 can be mounted on the coating 127, as shown in FIG. 9. Some of the rays 155 that are not specularly reflected by the reflective surface 127 can strike the photodetector 107. Accordingly, the photodetector 107 is able to sample a portion of the light emitted by the laser 105, and transmission monitoring can be performed to verify and/or adjust the laser power level during operation of the optical engine 100 (not shown in FIG. 9). The amount of light reaching the photodetector 107 is substantially proportional to the emitted laser power. The amount of light reaching the photodetector 107 is also substantially proportional to the optical power transmitted through the optical fiber 112, because the fraction of scattered light from the reflector is independent of the incident power level. The photodetector 107 can be used in transmitting channels with a laser 105, as shown in FIG. 9, and can also be used in receiving channels. In transmitting channels, the photodetector 107 captures a portion of a transmit light beam that leaks through the reflective surface 125. In a receiving channel, the photodetector 107 could be a lower bandwidth, higher sensitivity photodetector that detects lower speed signals that the TIA does not output. The photodetector 107 may be encased in a second encapsulating layer to isolate any electrical connections to the photodetector 107 from the surrounding environment.

FIG. 10 shows a reflector 124 textured according to the processes described above. The reflector 124 has four channels denoted as channels 0, 1, 2, and 3, respectively. The second layer 404 of the reflector 124 is a reflective layer, and is a gold layer in the reflector 124 shown in FIG. 10. The reflective layer was textured by raster scanning a pulsed laser over the reflector 124. Each channel used a different number of raster scans to form the texturing. Channel 0 used the most raster scans, followed by channel 1 with fewer raster scans, channel 2 still fewer raster scans, and channel 3 with the fewest raster scans. As an example, channel 0 can use about 15 raster scans, channel 1 can use about 10 raster scans, channel 2 can use about 5 raster scans, and channel 3 can use a single raster scan. As shown in FIG. 10, channels 0 and 1 have an irregular, blistered appearance that results from too many raster scans being used to form the textured surface. This level of texturing for channels 0 and 1 is generally unsuitable for optical systems, because the channels 0 and 1 will have degraded reflective properties after encapsulation due to the index of refraction between the channels 0 and 1 and the encapsulant not providing a TIR surface. Channel 2 shows a limit of raster scans that can be used, such that the reflector 124 is preferably textured by between 1 and 5 raster scans. Channel 2 can provide sufficient reflective properties if channel 2 is not encapsulated. However, if channel 2 is encapsulated, reflective properties can vary due to manufacturing tolerances any may result in unsuitable reflective surface. Channel 3 shows a very regular pattern on the textured surface with much of the gold surface still intact. This level of texturing is generally applicable to use in an optical system. In FIG. 10 the encapsulant has not yet been applied.

The process 500 shown in FIG. 8 describes a textured coating formed by applying an encapsulating layer after texturing the reflective laser. In other embodiments, the texturing may be performed after the reflective layer has been encapsulated. In this embodiment, the encapsulating layer is transparent to the laser wavelength forming the textured surface. The laser is focused on or near the reflective layer. Accordingly, the laser pulses do not have sufficient intensity to spoil or damage the outer surface of the encapsulant layer but have sufficient intensity to locally modify the reflective layer. A focused laser with ultrashort pulses, that is, picoseconds or femtosecond pulse lengths operating at visible or near-infrared wavelengths, may be particularly applicable to this process of fabricating a textured surface.

Other features may be included in an optical block 100 having a textured reflective coating. For example, the optical block 110 can include features to isolate the individual channels from each other. Slits can be formed in the optical block 110 between the channels and filled with a light absorbing material to isolate the channels. A textured coating can be combined with a bulk attenuator. The bulk attenuator provides a uniform or substantially uniform attenuation level to all channels, and then each channel can be individually adjusted by texturing. This combined system has the advantage of reducing the attenuation range required from the textured surface.

The optical block 100 with a textured coating described above may be incorporated into an optical transmitter or transceiver. The optical transceiver or transmitter may be sealed so that the optical path within the transmitter or transceiver is isolated from the surrounding environment. As shown, for example, in FIG. 2, the component chamber 162 may be isolated from the environment using an adhesive seal between the optical block 110, the riser 108 and the substrate 102 as described in the '994 application. FIG. 5 shows that the textured reflective surface 125 is isolated from the environment by the third layer 406. Thus, the entire optical path between the laser 105 and fiber 112 may be isolated from the environment.

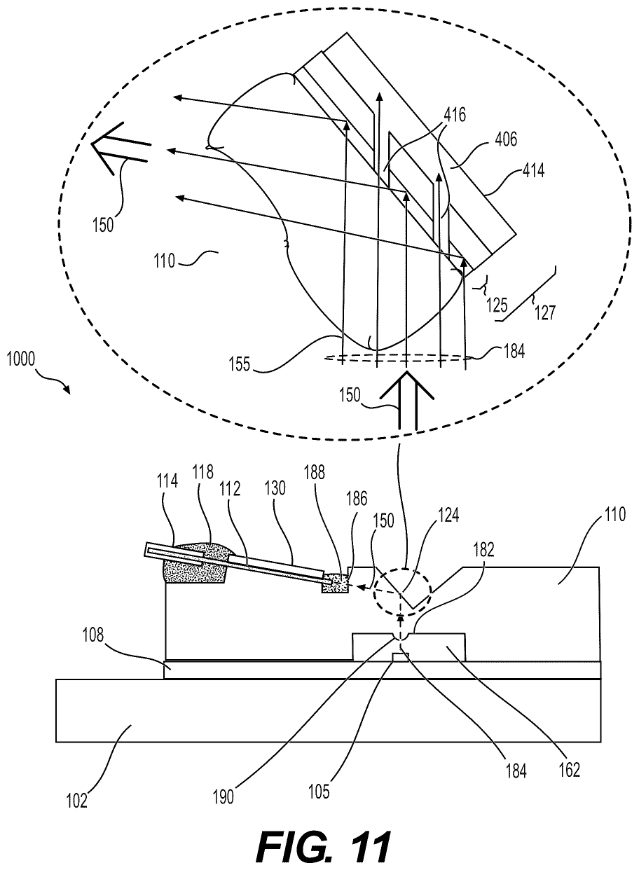

FIG. 11 shows a cross-sectional view of an optical path 150 in a portion of an optical engine 1000. Many of the elements of this figure are similar to those already described relative to FIG. 2 and the description of similar components may not be repeated for brevity. Unlike the prior art, the reflector 124 includes a textured surface that includes a coating 127 with a reflective surface 125 that is isolated from its surrounding environment. As such, the reflective properties of the reflective surface 125 are unaffected by liquids or contaminants, such as particulate matter, that may contact an outer surface 414 of the coating.

In FIG. 11, an optical block 110 may have a first surface 182 arranged to receive a light beam 184 generated by a laser 105. The laser 105 may be mounted on a riser 108, and the riser 108 may be mounted on a substrate 102. The light beam 184 has an input optical power. The optical block 110 may have a lens 190 on the first surface 182 to focus the light beam 184 on to an end of fiber 112. Accordingly, rays 155 of the light beam 184 may converge as they propagate through the optical block. The light beam 184 may be reflected off a reflector 124 with the reflective surface 125 arranged to receive the light beam 184 from the first surface 182 and redirect the light beam to a second surface 186 of the optical block 110. The second surface 186 may be arranged to output the light beam having an output optical power from the optical block 110. The second surface 186 may be flat. A transparent second encapsulant 188 may fill the region between the second surface 186 and the end of the fiber 112. The reflective surface may include a coating 127, details of which are shown in the inset in FIG. 11. The coating 127 is textured to deliberately spoil the reflective surface 125, thereby attenuating the input optical power so that the output optical power has a predetermined output optical power. The reflective surface 125 is encapsulated by the third layer 406, which may be an encapsulating layer, so that its reflective properties are not affected by liquids or contaminants that may be present on an outer surface 414 of the coating 127. The transparent second encapsulant 188 may be the same or different than the third layer 406 that seals the reflective surface 125 of the coating 127.

If the component chamber 162 is sealed or filled with an encapsulant, the entire optical path 150 of the light beam 184 can be isolated from the surrounding environment. In this case, the optical path 150 between the laser 104 and end of the fiber 112 goes first through the component chamber 162, second through the optical block 110, and third through the transparent encapsulant 188. The reflective surface 125 of the optical block is encapsulated, and thus the reflective surface 125 is also isolated from the surrounding environment. According to the features described above, the optical engine 1000 can be implemented in systems that use immersion cooling or that may experience fog or salt-water spray.

It should be appreciated that the illustrations and discussions of the embodiments shown in the figures are provided as examples only and should not be construed limiting the disclosure. One skilled in the art will appreciate that the present disclosure contemplates various embodiments. While the embodiments of the present invention have been described in terms of a textured surface of an optical surface in an optical engine, the concepts of the embodiments of the present invention can be applied more broadly. For example, any optical data transmission system requiring attenuation can use the techniques described above to attenuate an optical signal by modifying a coated optical surface in the optical path of the system. Additionally, it should be understood that the concepts described above with the above-described embodiments may be employed alone or in combination with any of the other embodiments described above. It should be further appreciated that the various alternative embodiments described above with respect to one illustrated embodiment can apply to all embodiments as described herein, unless otherwise indicated.

1: An optical block comprising:
a first surface that is arranged to receive a light beam having an input optical power;
a second surface that is arranged to output, from the optical block, the light beam with an output optical power; and
a reflective surface that is encapsulated, that is arranged to receive the light beam from the first surface and redirect the light beam to the second surface, and that includes a coating, wherein
the coating includes a texture provided by deliberately spoiling the reflective surface to attenuate the input optical power and to provide the output optical power with a predetermined output optical power.

2: The optical block of claim 1, further comprising a plurality of data transmission channels.

3: The optical block of claim 2, wherein an attenuation level of at least two of the plurality of data transmission channels is different.

4: The optical block of claim 2, wherein an attenuation level of all of the plurality of data transmission channels is a same attenuation level.

5: The optical block of claim 1, wherein the coating includes a reflective layer that is covered by an encapsulant layer.

6: The optical block of claim 5, wherein the coating includes an adhesion layer provided between the optical block and the reflective layer.

7: The optical block of claim 1, wherein the texture is uniform or substantially uniform over an intersection region where an optical path of the light beam intersects with the reflective surface.

8: The optical block of claim 1, wherein the texture is defined by a plurality of locally modified regions.

9: The optical block of claim 1, wherein the texture is defined by defects in the coating.

10: The optical block of claim 9, wherein the defects include laser markings.

11: The optical block of claim 9, wherein the defects are arranged in a regular array.

12-14. (canceled)

15: A sealed optical engine comprising;
the optical block of claim 1, and
a sealed component chamber.

16-17. (canceled)

18: A method of attenuating a light beam reflected from a reflective surface to a predetermined output power level, the method comprising:
deliberately spoiling the reflective surface to attenuate the light beam to a predetermined output power level; and
applying an encapsulant to isolate the reflective surface from a surrounding environment.

19: The method of claim 18, wherein deliberately spoiling the reflective surface includes raster scanning a pulsed laser over a coating of the reflective surface.

20: The method of claim 18, wherein the light beam reflected from the reflective surface is coupled into an optical fiber.

21: The method of claim 18, wherein a plurality of light beams is reflected from the reflective surface.

22: The method of claim 21, wherein an attenuation level of each of the plurality of light beams is individually adjusted.

23: The method of claim 22, wherein the predetermined output power level of each of the plurality of light beams is attenuated to a same power level.

24: The method of claim 18, wherein the reflective surface includes a reflective layer that is spoiled to attenuate the light beam.

25: The method of claim 24, wherein the reflective layer is ablated by a pulsed laser.

26: An optical data transmission system comprising a coated and textured reflective surface arranged to attenuate an optical beam, wherein the coated and textured reflective surface is encapsulated.
